(19) United States
(12) Patent Application Publication
(10) Pub. No.: US 2025/0256571 A1
(43) Pub. Date: Aug. 14, 2025

(54) Head-Up Display Having a Curved Image Generator for Directly Reflecting a Planar Virtual Image Via the Windshield

(71) Applicant: Bayerische Motoren Werke Aktiengesellschaft, Muenchen (DE)

(72) Inventors: Michael Arthur JANZER, Unterschleissheim (DE); Jasper STERN, Muenchen (DE)

(21) Appl. No.: 19/040,102

(22) Filed: Jan. 29, 2025

(30) Foreign Application Priority Data
Feb. 12, 2024 (DE) 10 2024 103 867.5

(51) Int. Cl. B60K 35/23; B60K 35/28

(52) U.S. Cl. CPC B60K 35/23; B60K 35/28; B60K 2360/23; B60K 2360/31; B60K 2360/334; B60K 2360/785

(57) ABSTRACT

An image generator for use in a vehicle comprises an image generating surface in which a respective desired display content is to be generated as a real image. The image generating surface is arranged opposite to the vehicle window so that the display content is reflected from the vehicle window directly to the eyes of at least one vehicle occupant. The image generating surface has a curvature at least in one direction. The curvature at least partially counteracts an interfering effect of a concave vehicle window shape on the virtual image such that the display content is displayed as a substantially planar virtual image in the field of view of the at least one vehicle occupant via reflection on the vehicle window.

### CROSS REFERENCE TO RELATED APPLICATION

This application claims priority under 35 U.S.C. § 119 from German Patent Application No. DE 10 2024 103 867.5, filed Feb. 12, 2024, the entire disclosure of which is herein expressly incorporated by reference.

### BACKGROUND AND SUMMARY

The invention relates to an image generator for a field-of-view display device for use in a vehicle, which is designed to show a virtual image in the field of view of at least one vehicle occupant via reflection on a vehicle window. Field-of-view display devices of this type are also known under the name head-up display (HUD). The invention is also directed to the field-of-view display device and a vehicle equipped therewith, which can be designed, for example, as a motor vehicle or another type of land, air, or water vehicle.

Using a head-up display, for example, speed limits and other useful navigation, warning, and vehicle operation notifications can be superimposed in the form of a virtual image in a motor vehicle on the real environment in front of the vehicle observed by the driver and/or another occupant. For passengers, entertainment content such as video films and much more can also be displayed during the journey in this way. Among other things, a simplified HUD design is known for generating a large scale or panoramic virtual display, in which an image generator is positioned without further imaging or projection optical units such as mirrors, etc. directly opposite to the windshield in its windshield base area, which is therefore often referred to as a “mirrorless HUD”.

FIG. 1a shows a very simplified perspective representation diagonally from above of a detail of a vehicle 10 having a mirrorless HUD 20 according to the prior art. The real image 40 generated by its image generator 30 in an image generating surface 80 is reflected in this simplified HUD design directly in a windshield 50 of the vehicle 10 and thus reaches the eyes 60 of the observer, such as a driver and/or front passenger. A virtual image 70 thus results in their field of view beyond the windshield 50. An associated light beam bundle L is indicated in FIG. 1a by its center beam, which leads from a center of the image generating surface 80 into a center of a spatial area (eye box) predetermined for the eyes 60 of the respective observer in the passenger compartment of the vehicle 10.

Current head-up display systems typically use a planar display screen as the image generator. In most cases, an LCD display (liquid crystal display screen) having a strongly bundled, bright backlight is used. The virtual image which results by the reflection on the windshield is usually also to appear as planar and stable as possible over a defined observation area. In order to compensate for optical influences of the windshield, which result, for example, in a deformation of the virtual image, in general aspheric mirrors are used.

In a mirrorless HUD 20 as in FIG. 1a, no mirrors are available to compensate for imaging errors or image deformations, which are caused by the windshield curvature. In a first approach, only one (solely schematically indicated in FIG. 1a) image pre-distortion of the real 2D image 40 can here be applied to the planar image generating surface 80 of the image generator 30 in order to cause the virtual image 70 to nonetheless appear as planar and rectangular as possible for the observer or observers. Depending on the geometric shape of the windshield 50, however, the virtual image 70 is deformed by different strengths in the vehicle longitudinal direction. With typical windshield curvatures, the virtual image 70 is represented as convex over the vertical direction from the viewpoint of the occupant, and is represented as concave over the horizontal direction from the viewpoint of the occupant, as shown in FIG. 1a. This can interfere in the display of long linear objects in the HUD 20.

It is an object of the present invention to provide a display device that is alternative and/or improved with regard to the installation space, the display options, the display quality, and/or other aspects for an HUD system in a vehicle.

At least this object is achieved by an image generator, a field-of-view display device containing such image generator, and a vehicle equipped therewith, in accordance with the embodiments described herein. It will be understood that the features and aspects described herein for the image generator also apply with respect to the field-of-view display device and the vehicle, and vice versa.

In at least one embodiment, an image generator for use in a vehicle is provided. The vehicle can in particular be a motor vehicle, but also any other land, air, or water vehicle. If not indicated otherwise, all position specifications and spatial orientation terms mentioned herein such as “vertical”, “horizontal”, “left”, “right”, “in front of”, “behind”, “underneath”, “above”, etc. relate to the typical vehicle-fixed Cartesian coordinate system having longitudinal, transverse, and vertical directions of the vehicle perpendicular to one another.

The image generator is designed to show the most planar possible virtual image in the field of view of at least one vehicle occupant via reflection on a vehicle window. It comprises an image generating surface, in which a respective desired display content can be generated as a real image and which is designed to be arranged opposite to the vehicle window such that this display content is reflected from the vehicle window directly to the eyes of the at least one occupant or to his eye box, i.e. without further deflection or imaging optical units in the beam path between the image generator and the occupant. Together with the vehicle window, the image generator therefore forms a field-of-view display device, in particular a head-up display (HUD), of the above-mentioned simplified (mirrorless) design. An eye box is understood herein as usual as a two-dimensional or three-dimensional spatial area in the vehicle from which the virtual image is visible in the intended quality.

The vehicle window can in particular be a windshield, but alternatively also a rear window or side window of the vehicle. As is typical, it is concavely curved on the vehicle inside. The image generating surface is also formed curved in at least one direction here in order to reduce or compensate for an interfering effect of the vehicle window curvature on the virtual image to be displayed planar at least in one direction (for example, horizontal or vertical). In other words, the curvature of the image generating surface is designed to at least partially counteract undesired deformations of the display content upon its reflection on a concavely curved inner surface of the vehicle window, which would cause the virtual image to appear uneven and having distorted angle relationships.

An aspect of at least one embodiment is thus to minimize the above problem of an interfering bulge/deformation of a virtual image to be displayed planar due to the windshield curvature even with a mirrorless HUD by using a curved image generator. The image generating surface of the image generator can have for this purpose, for example, in at least one direction a curvature shape inverted in relation to the windshield shape in a suitable manner or compensating for it. In this way, the virtual image can be “flattened out”. A two-dimensional “predistortion” of the real image mentioned at the outset in the image generating surface can be optionally (but not necessarily) applied for this purpose for additional assistance of this effect.

The curvature of the image generating surface can in particular be tailored specifically to a predetermined vehicle window geometry in order to achieve the best possible result for the virtual image. The curvature of the image generating surface can alternatively also be suitable for multiple different vehicle windows, however, in that it is optimized, for example, for an average vehicle window and thus can also result in a significant improvement in comparison to the prior art.

As mentioned at the outset and illustrated in FIG. 1a, the virtual image appears convex over the vertical direction from the viewpoint of the occupant and appears concave over the horizontal direction from the viewpoint of the occupant with typical windshield curvatures. To reduce or compensate for these image field bulges, the image generating surface can be curved concavely, for example, in a first direction and curved convexly in a second, in particular orthogonal, direction independent thereof.

A solution presented herein can be particularly relevant for field-of-view display devices or head-up displays having a large virtual image (for example, for a panoramic display) and/or having a visibility for multiple vehicle occupants at the same time (for example, for a driver and a front passenger). For different viewing positions, such as driver and front passenger, the effect of a curved virtual image can be only ineffectively alleviated by the image predistortion mentioned at the outset, since this can be optimized only for a specific observation position. With large virtual images, the relationship between image field curvature and image size becomes more unfavorable and thus more noticeable. A planar virtual image can also be generated in such applications by a curvature of the image generator counteracting the window curvature.

In principle, any imaging technology is suitable for the image generator. It can be designed, for example, as a display having a two-dimensional matrix of electrically actuatable pixels which forms the mentioned image generating surface. In particular, in this case it can be a light-transmitting or light-emitting flat display screen, such as a liquid crystal display screen (LCD), or a μLED or OLED display. Alternatively, however, it can also be a projector-based image generator, which comprises a projector for generating a light beam bundle having the desired display content and a projection screen (also called a screen) illuminated thereby, which forms the mentioned image generating surface.

According to at least one embodiment, the image generating surface is cylindrically curved. If, for example, the image generator can only be cylindrically curved for technical reasons or reasons of installation space, at least the virtual image field bulges can thus be minimized in one direction. A cylindrical embodiment of the image generator is easier to display using most display technologies, in particular using display technologies such as LCD, OLED, or μLED, than a significantly more complex spheric or aspheric shape. For example, when virtual image content is reflected via the windshield, image field bulges in the vertical direction are usually significantly more noticeable than in the horizontal direction. These image field bulges can be deliberately reduced or eliminated using a cylindrical curvature of the display area in a corresponding direction.

According to at least one embodiment, the image generating surface is curved in two independent directions. It can be curved spherically or aspherically, for example. Its curvature properties can remain constant along its surface or vary from point to point. Such curvature properties are in particular implementable well using an image generator which uses a projection technology on a light-diffusing screen for image generation. The screen can be manufactured here, for example, as a deep drawn, diffusely-reflective film. Alternatively, the screen can also be designed as a spherically or aspherically curved optical injection molded plate. For example, plastic having properties suitable for this purpose is suitable as a material for such a screen.

Both a cylindrical and a spheric or aspheric curvature of the image generator can moreover contribute, due to an accompanying collimation effect, to a homogeneous illumination of the occupant viewing area (eye box). In addition, a cylindrical or spherically/aspherically curved image generating surface can also offer installation space advantages over a planar image generating surface of the same area size, in that its lateral dimensions become smaller due to the curvature.

According to at least one embodiment, the above field-of-view display device is provided for a vehicle. It comprises the image generator presented herein and the mentioned vehicle window, which is concavely curved on the image generator side and is arranged or is to be arranged in the beam path of a light beam bundle output by the image generator in operation, such that it reflects the display content generated in the image generator directly to the eyes of the at least one occupant or to his eye box. In this case, the mentioned curvature of the image generating surface is designed to reduce and ideally compensate for the effect of the vehicle window curvature on the virtual image at least in the mentioned direction, so that it can be displayed as straight or angle-faithful or planar as possible at least with respect to this direction.

In particular, the image generating surface can have a curvature shape inverted to the vehicle window (or to an image field bulge caused by its curvature) in at least one direction such that it compensates for the effect of the vehicle window curvature on the virtual image at least in this direction.

In the case of an above-mentioned cylindrical curvature of the image generating surface, its cylinder axis can be aligned along its front edge located closest to the vehicle window or along a window base and the curvature can be concave from the viewpoint of the occupant (or in the view from the direction of the vehicle window). The above-mentioned convex image field bulge can thus be reduced or compensated for around a horizontal image axis. Alternatively, a cylinder axis of the cylindrically curved image generating surface can be aligned along its side edges or orthogonal to a window base and the curvature of the image generating surface can be convex from the viewpoint of the occupant (or in the view from the direction of the vehicle window). The above-mentioned concave image field bulge can thus be reduced or compensated for around a vertical image axis.

A combination of these two variants in an aspherically curved image generating surface is also possible.

According to at least one embodiment, the above vehicle is provided. It comprises a passenger compartment and a vehicle window, which at least partially delimits it, in particular a windshield. Furthermore, the above field-of-view display device is provided in the vehicle, the image generator of which is arranged in the passenger compartment, in particular in an instrument panel arranged below the windshield, and the vehicle window of which is the mentioned vehicle window of the vehicle.

The above aspects of the invention and their embodiments and specific designs will be explained in more detail hereinafter on the basis of the examples illustrated in the appended drawings. The drawings are predominantly schematic and therefore are not to be understood as being to scale.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1a shows a perspective view of a detail of a vehicle having a conventional mirrorless HUD, the virtual image of which, which is to be displayed planar, has an image field bulge;

FIG. 1b shows a perspective view of a detail of a vehicle having a field-of-view display device according to an exemplary embodiment of the invention, which enables a planar virtual image display;

FIG. 2a shows a vertical longitudinal sectional representation of the vehicle of FIG. 1a; and

FIG. 2b shows a vertical longitudinal sectional representation of a vehicle having a field-of-view display device according to a further exemplary embodiment of the invention, which enables a straight or planar virtual image display in the vertical direction.

### DETAILED DESCRIPTION OF THE DRAWINGS

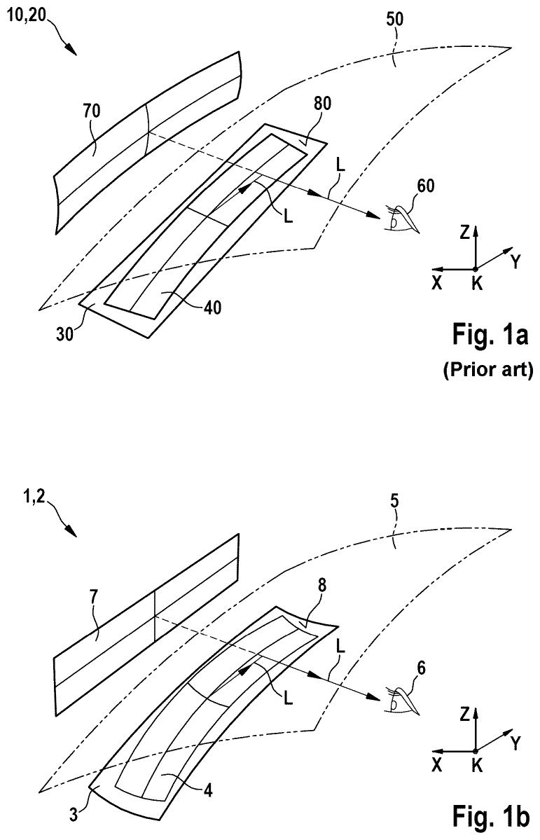

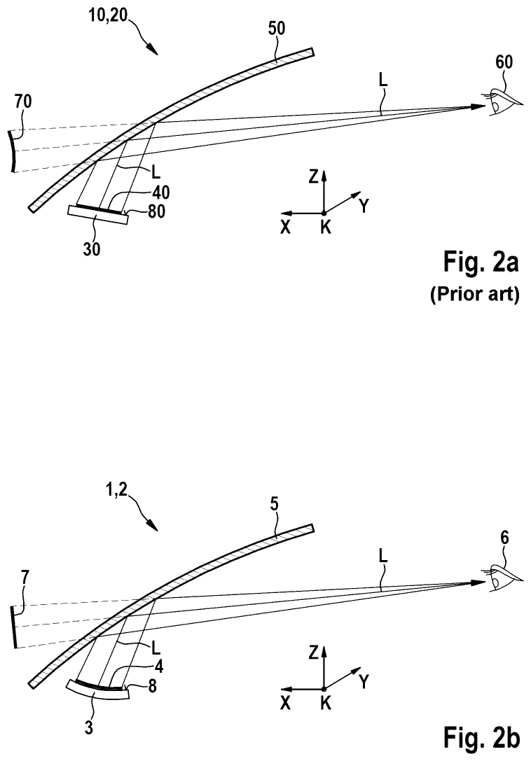

All further different embodiments, variants, and specific design features mentioned above in the description and in the following claims of the image generator, the field-of-view display device, and the vehicle according to the above aspects of the invention can be implemented in the examples shown in FIGS. 1b and 2b, in particular also alternatively or additionally to the features shown therein. They are therefore not all repeated once again hereinafter. This also applies accordingly to the further term definitions and effects already indicated above with respect to individual features shown in FIGS. 1b and 2b.

FIG. 1b shows a greatly simplified perspective illustration diagonally from above of a detail of a vehicle 1 having a field-of-view display device 2 according to an exemplary embodiment of the invention. The spatial orientation terms used hereinafter such as “horizontal”, “vertical”, “above”, “below”, “underneath”, etc. relate to the typical vehicle-fixed Cartesian coordinate system K having longitudinal, transverse, and vertical directions X, Y, and Z of the vehicle 1 perpendicular to one another.

The vehicle 1 is in this example a motor vehicle, which is only indicated in FIG. 1 by its windshield 5, which forms a part of the field-of-view display device 2. An image generator 3 of the field-of-view display device 2 is arranged underneath this in an instrument panel (not shown in more detail). In this example, the basic design is a mirrorless HUD, the conventional design of which was described at the outset with reference to FIG. 1a.

A real image 4 generated by the image generator 3 in its image generating surface 8 is directly reflected in the windshield 5 in this simplified HUD design and thus reaches the eyes 6 of the observer, such as a driver and/or front passenger of the vehicle 1. A virtual image 7 thus results in their field of view beyond the windshield 5. An associated light beam bundle L is indicated in FIG. 1b by its center beam, which leads from a center of the image generating surface 8 into a center of a spatial area (eye box, not shown) predetermined for the eyes of the respective occupant in the passenger compartment of the vehicle 1.

In contrast to the conventional embodiment having a planar image generating surface 80 according to FIG. 1a, the image generating surface 8 of the image generator 3 according to FIG. 1b is formed curved and in this example has a curvature shape inverted in relation to the windshield 5. In this case, the image generating surface 8 is curved concavely in a first direction (around a first axis of curvature, which extends approximately along the vehicle transverse direction Y) and is curved convexly in a second direction independent thereof (around a second axis of curvature, which extends approximately along the vehicle longitudinal direction X). In this way, the virtual image 7 can be “flattened out” in comparison to FIG. 1a, i.e. the undesired image field bulges in the virtual image 70 as in FIG. 1a, which originate from the windshield curvature, can thus be eliminated.

If the image generator 3 can only be cylindrically curved for technical reasons or reasons of installation space, at least the virtual image field bulges can be minimized in one direction. This is illustrated on the basis of an example with reference to FIGS. 2a and 2b:

FIG. 2a shows the vehicle 10 of FIG. 1a once again in a vertical longitudinal section, wherein edge beams of the light beam bundle L, which contributes to the virtual image generation, are additionally also indicated. In this view, the typical convex bulge of the virtual image 70 already mentioned above can be seen well in the vertical or height direction Z of the vehicle 10, which arises due to the routine windshield geometry.

FIG. 2b shows, also in a vertical longitudinal section, a vehicle 1 having a field-of-view display device 2 according to a further exemplary embodiment of the invention, which in contrast to FIG. 2a enables a virtual image display flattened out in the vertical direction (i.e. in the vertical direction Z of the vehicle 1). For this purpose, the image generating surface 8 of the image generator 3 is formed having a cylindrical curvature inverted in relation to the windshield curvature in a suitable manner, the cylinder axis of which extends approximately along a window base of the windshield 5. Otherwise, reference is made to the above description of FIG. 1b, which is also to be applied accordingly to FIG. 2b, to avoid repetitions. Edge beams of a light beam bundle L, which contributes to the virtual image generation, are additionally also indicated in FIG. 2b.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 vehicle
2 field-of-view display device
3 image generator
4 real image
5 windshield
6 eyes of the observer/occupant
7 virtual image
8 image generating surface of the image generator
L light beam bundle
K vehicle-fixed Cartesian coordinate system
X, Y, Z longitudinal, transverse, and vertical directions of the vehicle
10 conventional vehicle
20 conventional mirrorless HUD
30 image generator
40 real image
50 windshield
60 eyes of the observer/occupant
70 virtual image

What is claimed is:

1. An image generator for use in a vehicle, comprising:
an image generating surface, in which a respective desired display content is to be generated as a real image,
wherein the image generating surface is arranged opposite to the vehicle window so that the display content is reflected from the vehicle window directly to the eyes of at least one vehicle occupant,
wherein the image generating surface has a curvature at least in one direction,
wherein the curvature at least partially counteracts an interfering effect of a concave vehicle window shape on the virtual image such that the display content is displayed as a substantially planar virtual image in the field of view of the at least one vehicle occupant via reflection on the vehicle window.

2. The image generator of claim 1, wherein the image generating surface is cylindrically curved.

3. The image generator of claim 1, wherein the image generating surface is curved in two independent directions.

4. The image generator of claim 3, wherein the image generating surface is concavely curved in a first direction and is convexly curved in a second direction independent thereof.

5. The image generator of claim 1, wherein the image generator comprises:
a display having a two-dimensional matrix of electrically actuatable pixels, which form the image generating surface, or
a projector-based image generator having a projector for generating a light beam bundle and a projection screen illuminated thereby, which forms the image generating surface.

6. A field-of-view display device for a vehicle, comprising:
the image generator of claim 1; and
a vehicle window concavely curved on the image generator side, wherein the vehicle window is arranged in a beam path of a light beam bundle output by the image generator so that the vehicle window reflects the display content generated in the image generating surface directly to the eyes of the at least one occupant,
wherein the curvature of the image generating surface reduces or compensates for the effect of the vehicle window curvature on the virtual image at least in a first direction so that the virtual image is displayed substantially straight or planar at least with respect to the first direction.

7. The field-of-view display device of claim 6, wherein the image generating surface has a curvature shape inverted in relation to the vehicle window in at least the first direction, in order to compensate for the effect of the vehicle window curvature on the virtual image at least in the first direction.

8. The field-of-view display device of claim 6,
wherein the image generating surface is cylindrically curved, and
wherein a cylinder axis of the cylindrically curved image generating surface:
is aligned along its front edge located closest to the vehicle window or along a window base of the vehicle window, and the curvature of the image generating surface is concave viewed from the direction of the vehicle window, or
is aligned along its lateral edges or orthogonally to a window base of the vehicle window, and the curvature of the image generating surface is convex viewed from the direction of the vehicle window.

9. The field-of-view display device of claim 6,
wherein the image generating surface is curved in two independent directions,
wherein a first curvature axis of the image generating surface is aligned along its front edge closest to the vehicle window or along a window base of the vehicle window, and the associated curvature of the image generating surface is concave viewed from the direction of the vehicle window, and
wherein a second axis of curvature of the image generating surface is aligned along its lateral edges or orthogonally to a window base of the vehicle window, and the associated curvature of the image generating surface is convex viewed from the direction of the vehicle window.

10. A motor vehicle, comprising:
a passenger compartment having a windshield; and
the field-of-view display device of claim 1, wherein the image generator is arranged in an instrument panel of the vehicle below the windshield.
